(19) United States
(12) Patent Application Publication
(10) Pub. No.: US 2005/0200772 A1
(43) Pub. Date: Sep. 15, 2005

(54) Front lighted micro-LCD

(76) Inventor: Heyg-Kyu Song, Seoul (KR)

Correspondence Address: William G. Lane;William G. Lane, Inc., P.C., Suite 250, 16485 Laguna Canyon Road, Irvine, CA, 92618, US

(21) Appl. No.: 10/789,366

(22) Filed: Feb. 27, 2004

(51) Int. Cl. G02F 1/1335

(52) U.S. Cl. 349/63

(57) ABSTRACT

A front lighted micro liquid crystal display comprising an L-shaped wedge prism, a prismic lens positioned adjacent the L-shaped wedge prism with a polarizing media and a partial transmission mirror sandwiched therebetween. The L-shaped wedge prism having a leg portion and a foot portion; light being emitted into the leg portion which is reflected through the prism onto the liquid crystal display and the illuminated image of the liquid crystal display passes through the foot portion of the L-shaped wedge prism through the polarizing medium, through the partial transmission mirror, and through the prismic lens for viewing the image.

### FIELD OF THE INVENTION

The field of the invention is a front lighted LCD device.

### BACKGROUND OF THE INVENTION

LCD's, liquid crystal devices, can be back lighted or front lighted. Liquid crystal devices are used extensively in electronics, electronic equipment such as small scientific and medical instruments and airplane control panels, appliances such as microwave ovens, refrigerators television and DVD players, and the like. Liquid crystal displays are also used in hand-held computers and calculators. There is a continuing drive to reduce the size of electronics and electronic equipment and their components. There is a continuing drive to reduce the power consumption and heat load of the components of electronics and electronic equipment.

The front lighted micro-LCD of the present invention furnishes a display equal to the size of the displays of conventional LCD devices but in a smaller package. The front light micro-LCD of the present invention has less light loss than conventional LCD devices, thus reducing the lighting requirements and reducing power consumption, and permitting greater contrast control for the LCD image.

### SUMMARY OF THE INVENTION

The present invention is directed to a front lighted micro liquid crystal display comprising a liquid crystal display, an L-shaped wedge prism with a leg portion and wedge foot portion, the wedge foot portion having a first surface adapted to receive liquid crystal display, an opposing sloped second surface, the leg portion having a top surface, a shoulder, a third surface extending from the top surface to the shoulder, the shoulder contiguous with the second sloped surface; a prismic lens with a sloped base having an angle of slope reciprocal to the angle of slope of the sloped second surface and an opposing front lens surface lying in a plane closely parallel to the plane of the first surface; a polarizing medium positioned next to the sloped second surface; a partial transmission mirror positioned between the partial polarizing medium and the sloped base; and a light source adapted to emit light into the top surface of the leg of the L-shaped wedge prism to illuminate the liquid crystal display so that the image of the liquid crystal display can be emitted through the prismic lens for viewing.

Preferably, the first surface has an antireflective coating and the sloped second surface has an antireflective coating.

The polarizing medium and the partial transmission mirror can be combined as a single component.

Preferably, the third surface and the shoulder are covered with reflective media. The reflective media can be a reflective pad, or the reflective media can be a reflective coating on the third surface and the shoulder.

Preferably, the light source is a light emitting diode array comprising a plurality of light emitting diodes.

Preferably, the partial transmission mirror is a 50% transmission mirror.

The polarizing media can be a polarizing film.

The components, i.e. the liquid crystal display, the L-shaped wedge prism, the polarizing media, the partial transmission mirror, and the prismic lens, of the front lighted micro liquid crystal display are positioned together within a frame. Preferably, the frame substantially blocks all light from exiting or entering the front lighted micro liquid crystal display except through the front lens surface of the prismic lens.

### BRIEF DESCRIPTION OF THE DRAWINGS

FIG. 1 is a schematic showing prior art front lighted LCD;

FIG. 2 is a schematic drawing of the front lighted micro-LCD of the present invention;

FIG. 3 is another schematic of the front lighted micro-LCD of the present invention;

FIG. 4 is a schematic showing light emitting diodes (“LED”) light source of the front lighted micro-LCD of FIG. 3;

FIG. 5A is a top plan view of the L-shaped wedge prism of the micro-LCD of the present invention;

FIG. 5B is a plan side view of the prism of FIG. 5A;

FIG. 5C is a right side plan end view of the prism of FIG. 5B;

FIG. 5D is a bottom view of the prism of FIG. 5A.

### DETAILED DESCRIPTION OF THE INVENTION

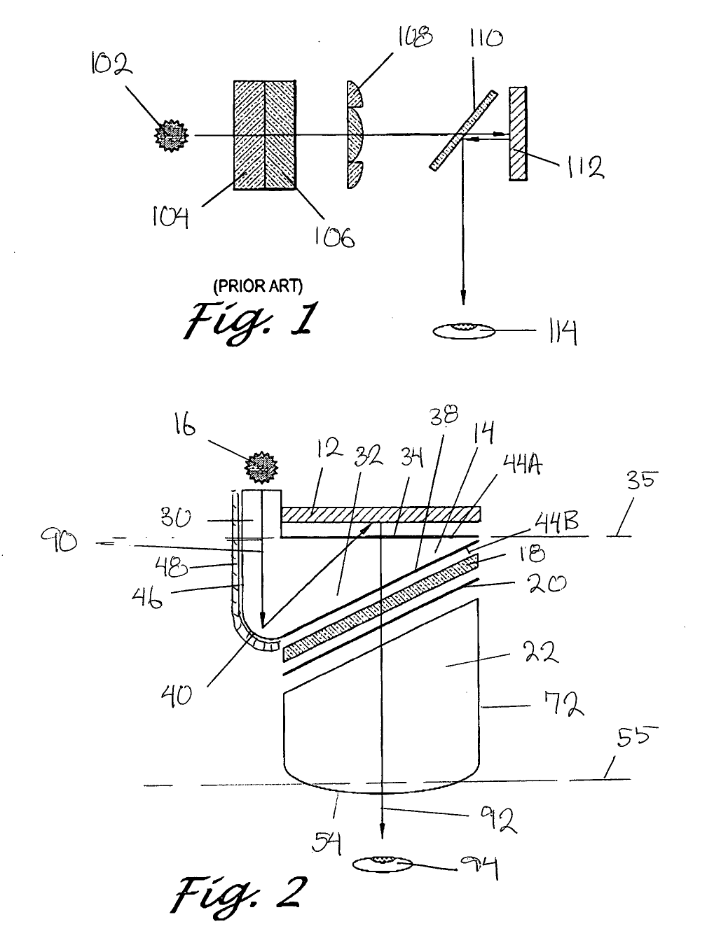

Referring to FIG. 1, the prior art front lighted LCD's (liquid crystal displays) comprise a light source 102, a polarizer 104, a diffuser 106, a Fresnel lens 108, a half mirror (50% transmission) 110, and a LCD 112. The light from the light source 102 is past through the polarizer and then diffuser and focused with the Fresnel lens 108. The focused light is passed through the half mirror 110 to illuminate the liquid crystal display 112. The LCD has a reflective back to reflect the light back out of the LCD. The light, or more correctly the lighted image, is reflected back to the half mirror and reflected to the viewer 114. A great deal of light is absorbed in the system reducing the contrast of the image and requires a bright light source, which increases power consumption, which in turn increases the heat output of the device. About 50% of the light from the light source is lost in polarizer 104. An additional 50% is typically lost in the diffuser 106. Only about 25% of the light from the light source reaches the Fresnel lens 108. Typically, the light loss in a Fresnel lens is 10-15%. About 50% of the light passing through the half mirror 110 is lost. Thus, only about 10-13% of the light from the light source reaches the LCD 112. The light or image reflected off the LCD is reflected off the half mirror reducing the image by about 50%. Thus, the observer sees an illuminated image which only has about 5-7% of the light from the light source input. This reduces the source contrast.

Referring to FIG. 2, the front lighted micro-LCD 10 of the present invention comprises a micro-LCD 12, an L-shaped wedge prism 14, a light source 16, preferably a light emitting diode array (“LED”), a polarizing medium 18, a partial transmission mirror 20, and a prismic lens 22. The L-shaped wedge prism 14 has a leg 30 connected to a wedge foot 32. The wedge foot 32 has a first surface 34 perpendicular to the image optical axis 36, a sloped second surface 38, a third surface 46, and a shoulder 40 contiguous with the second surface 38 with the third surface 46. The first surface has an antireflective coating 44A and the second surface has a antireflective coating 44B. The shoulder 40 and the third surface 46 are covered with a reflective pad 48. A reflective coating or a reflective plate such as a polished aluminum plate or stainless steel plate can be used in place of the reflective pad. Situated beneath the L-shaped wedge prism 14 is the prismic lens 22 which is in line with the optical axis 36. The prismic lens 22 has a base sloped surface 52 which has a reciprocal angle of the sloped second surface 38. The angle of the second sloped surface 38 is made reciprocal and the angle of the sloped base 52 is made reciprocal angles to render the plane of the prismic lens surface 54 parallel to the first surface 34 and the LCD 12 and perpendicular to the optical axis 36. Positioned next to the sloped second surface 38 is a polarizing medium 18, typically a polarizing film. Positioned next to the polarizing medium is a partial transmission mirror 20, conveniently a half mirror (50% transmission). The polarizing medium and partial transmission mirror can be combined as a single component. The sloped base 52 of the prismic lens 22 is positioned against the sloped second surface 38 of the prism 14 with the polarizing medium 18 and the partial transmission mirror 20 sandwiched therebetween.

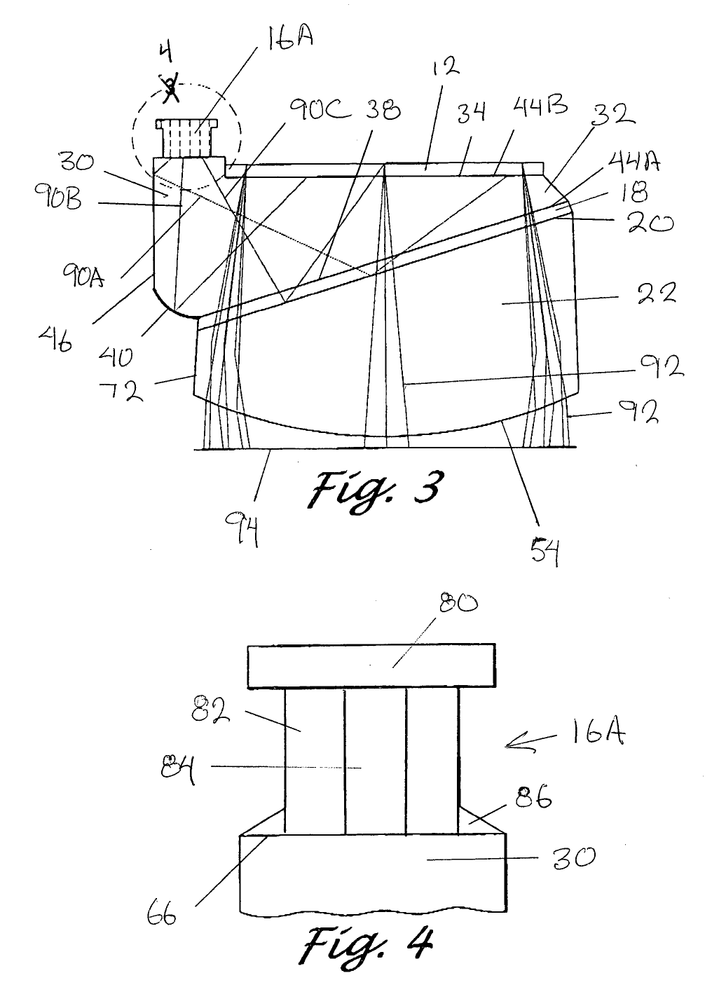

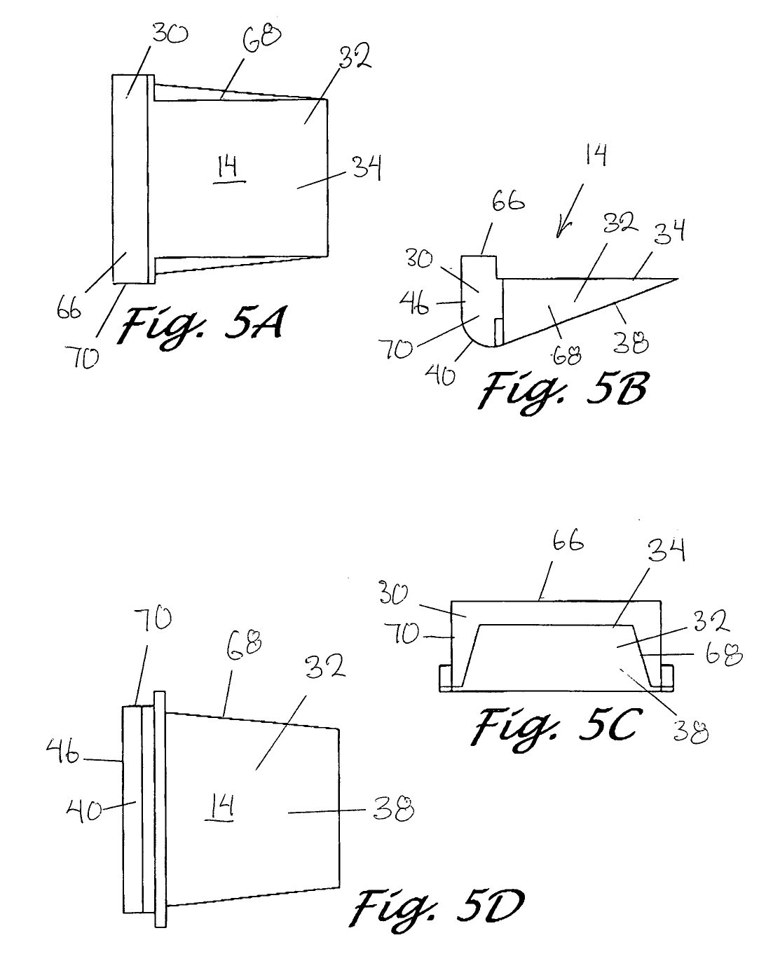

As explained below, light from the light source 16 passes through the leg 30 of the L-shaped wedge prism through light path 90 and is reflected off the surfaces 46 and 38 and shoulder 40 of the prism and reflected back through the first surface into the LCD 12 (FIG. 3). The illuminated image of the LCD is transmitted through the first surface 34 through the wedge shaped foot 32, through the sloped second surface 38, through the polarizing medium 18, through the partial transmission mirror 20, through the sloped base 52 of the prismic lens 22, through the prismic lens 22, and out through the front lens surface 54 of the prismic lens along the optical or image axis 92 so that the LCD information can be viewed by an observer 94.

About 5% of the light from the light source 16 is lost within the L-shaped wedge prism 14 so that the LCD 12 receives about 95% of the light from the light source. The image light loses about 5% of its light passing through the L-shaped wedge prism 14, about 50% passing through the polarizing medium, about 50% when passing through a half mirror, about 4% passing through the sloped base 52, and about 4% the front lens surface 54. Thus, the observer sees an illuminated image which has about 19% of the light from the light source input. In contrast, the prior art front lit LCD's only yield and image with about 5-7% of the light from the light source. The present invention gives a much higher image contrast. The front lit micro-LCD of the present invention illuminates the LCD with about 95% of the light from the light source. In contrast, the prior art front lit LCD's illuminate the LCD with only about 10-13% of the light from the light source.

Referring to FIG. 3, the light source, preferably an LED (light emitting diode) array comprising a plurality of LED chips mounted on a circuit board. Typically three LED's are mounted on a circuit board.

Referring to FIG. 4, an LED light source 16A comprising a plurality of LED's 82. We have found a chip with three LED's to be quite suitable for the present invention. A plurality of chips are mounted on a circuit board 80. The chips are aligned in a planer fashion on the circuit board 80 so that the entire length of the top surface 66 of the leg 30 (see FIG. 5A) is illuminated with a plurality of chips. The LED array 16A is secured to the top surface 66 of the leg 30 by silicon cement 86.

The components of the front lighted micro-LCD 10, except for the LED array 16A, are mechanically secured together with a holder or frame (not shown). The LCD 12 is positioned against the first surface 34. The polarizing medium 18 is positioned against the sloped second surface 38. The partial transmission mirror 20 is positioned against the polarized medium 18. The sloped base 52 of the prismic lens is positioned against the partial transmission mirror 20. An air space between the various components is kept to a minimum, such as less than 100 microns. The front lighted micro-LCD holder or frame (not shown) can also function as a light barrier to prevent light from escaping the device or entering the device through the sides 68 and 70 of the L-shaped wedge prism and the sides 72 of the prismic lens (FIGS. 2, 3, 5A, 5B, 5C, and 5D).

Referring to FIGS. 5A-5D, the L-shaped wedge prism 14 has the first surface 34 on which is positioned the LCD 12, the sloped second surface 38 which is positioned against the sloped base 52 of the prismic lens 22 with the polarizing medium 18 and the partial transmission mirror 20 sandwiched therebetween. The prism 14 has a leg 30 with a top surface 66 of the leg 30 of the prism 14 receives the light source, preferably an LED array 16A as described above. The third surface 46 and the shoulder 40 which is contiguous with the sloped second surface 38 and the third surface 46 are covered with a reflective pad (not shown) in FIGS. 5A-5D. The prism has sides 68 and 70 which are preferably shielded to prevent the ingress and egress of light.

Referring to FIG. 3, the LED array 16A emits light over 120 degrees and thus light emitted into the leg of the L-shaped wedge prism is reflected off the third surface 46, the shoulder 40, and the sloped second surface 38 back to the first surface to the LCD 12. Most of the light emitted by the LED array is reflected off the shoulder 40 and to and through the first surface 34. A substantial portion of the light emitted by the LED array reaches the LCD to illuminate it. About 95% of the light emitted into the leg of the L-shaped wedge prism illuminates the LCD. The emitted light and reflected light from the LED is identified by light paths 90A, 90B, and 90C in FIG. 3. The illuminated image 94 of the LCD is reflected back toward the prismic mirror 22 passing through the sloped second surface 38, the polarizing medium 18, normally a polarizing film, the partial transmission mirror, normally a 50% mirror, through the sloped base 52 of the prismic lens 22 through the lens and out the lens front surface 54 along image paths 92.

1. A front lighted micro liquid crystal display comprising a liquid crystal display, an L-shaped wedge prism with a leg portion and wedge foot portion, the wedge foot portion having a first surface adapted to receive liquid crystal display, an opposing sloped second surface, the leg portion having a top surface, a shoulder, a third surface extending from the top surface to the shoulder, the shoulder contiguous with the second sloped surface;
a prismic lens with a sloped base having an angle of slope reciprocal to the angle of slope of the sloped second surface and an opposing front lens surface lying in a plane closely parallel to the plane of the first surface;
a polarizing medium positioned next to the sloped second surface;
a partial transmission mirror positioned between the partial polarizing medium and the sloped base; and
a light source adapted to emit light into the top surface of the leg of the L-shaped wedge prism to illuminate the liquid crystal display so that the image of the liquid crystal display can be emitted through the prismic lens for viewing.

2. The front lighted micro liquid crystal display according to claim 1 wherein the first surface has an antireflective coating and the sloped second surface has an antireflective coating.

3. The front lighted micro liquid crystal display of claim 1 wherein the polarizing medium and the partial transmission mirror are combined as a single component.

4. The front lighted micro liquid crystal display of claim 1 wherein the third surface and the shoulder are covered with reflective media.

5. The front lighted micro liquid crystal display according to claim 4 wherein the reflective media is a reflective pad.

6. The front lighted micro liquid crystal display according to claim 4 wherein the reflective media is a reflective coating on the third surface and the shoulder.

7. The front lighted micro liquid crystal display according to claim 1 wherein the first surface and the second sloped surface have an antireflective coating and the third surface and shoulder are covered by a reflective media.

8. The front lighted micro liquid crystal display according to claim 7 wherein the reflective media is a reflective pad.

9. The front lighted micro liquid crystal display according to claim 7 wherein the reflective media is a reflective coating.

10. The front lighted micro liquid crystal display according to claim 1 wherein the light source is a light emitting diode array comprising a plurality of light emitting diodes.

11. The front lighted micro liquid crystal display according to claim 1 wherein the partial transmission mirror is a 50% transmission mirror.

12. The front lighted micro liquid crystal display according to claim 1 wherein polarizing media is a polarizing film.

13. The front lighted micro liquid crystal display according to claim 1 wherein the components of the front lighted micro liquid crystal display are positioned together within a frame that substantially blocks all light from exiting or entering the front lighted micro liquid crystal display except through the front lens surface of the prismic lens.

14. The front lighted micro liquid crystal display according to claim 1 wherein the first surface and the sloped second surface have an antireflective coating, the third surface and the shoulder are covered by reflective media and the partial transmission mirror is a 50% transmission mirror.

15. The front lighted micro liquid crystal display according to claim 14 wherein the polarizing media is a polarizing film.

16. The front lighted micro liquid crystal display according to claim 14 wherein the reflective media is a reflective pad.

17. The front lighted micro liquid crystal display according to claim 14 wherein the components of the front lighted micro liquid display are bound together within a frame.

18. The front lighted micro liquid crystal display according to claim 14 wherein the frame substantially blocks all light from being exiting or entering the front lighted micro liquid crystal display except through the front lens surface of the prismic lens.

19. The front lighted micro liquid crystal display according to claim 1 wherein the polarizing medium and the partial transmission mirror are a single component.

20. The front lighted micro liquid crystal display according to claim 14 wherein the polarizing medium and the partial transmission mirror are a single component.
